(19) United States
(12) Patent Application Publication
(10) Pub. No.: US 2008/0311253 A1
(43) Pub. Date: Dec. 18, 2008

(54) GENDER-SPECIFIC HERBAL AND MINERAL SUPPLEMENT DRINKS

(75) Inventors: Thomas E. Mower, Springville, UT (US); Charles Jeffrey Brady, Provo, UT (US)

Correspondence Address: ALAN J. HOWARTH, P.O. BOX 1909, SANDY, UT, 84091-1909, US

(73) Assignee: SAKURA PROPERTIES, LLC, Salem, UT (US)

(21) Appl. No.: 12/140,176

(22) Filed: Jun. 16, 2008

Related U.S. Application Data
(60) Provisional application No. 60/934,854, filed on Jun. 15, 2007.

(51) Int. Cl. A23L 1/304; A23L 1/302; A23L 2/38

(52) U.S. Cl. 426/72; 426/590

(57) ABSTRACT

Gender-specific trace mineral-containing drink compositions for nutritional supplementation are described. Both the drinks intended for males and the drinks intended for females contain minerals, vitamins, flavors, and water. The drinks intended for males contain an extract of maca, whereas the drinks intended for females contain an extract of vitex.

### CROSS-REFERENCE TO RELATED APPLICATIONS

This application claims the benefit of U.S. Provisional Application No. 60/934,854, filed Jun. 15, 2007, which is hereby incorporated by reference.

### STATEMENT REGARDING FEDERALLY SPONSORED RESEARCH OR DEVELOPMENT

Not applicable.

### BACKGROUND OF THE INVENTION

This invention relates to dietary supplements. More particularly, this invention relates to dietary supplement drinks comprising gender-specific herbal nutrients and also comprising vitamins and minerals.

Due to the differing physiologies of men and women, nutritional requirements for men and women differ. Further, men and women are subject to different health conditions, thus they would benefit from nutritional supplements that are specifically targeted to each gender.

Nutrition experts report that there is an 86% increase in nutrient availability to the body when broad-spectrum trace mineral supplementation is used. Steven E. Whiting, Trace Mineral Supplementation and the Effect on Total Nutrient Serum Levels, Institute of Nutritional Science (June 1993). Trace minerals, extremely vital for optimal health, are the most absent nutrients in the modern diet.

Nutritional deficiencies make us susceptible to numerous ailments and to the toxic effects of chemicals. Henry A. Schroeder, 3(1) Health News & Review 12 (1993). When trace minerals are lacking in the body, disorders may occur in the digestive, circulatory, skeletal, and other body systems. When micronutrients are missing from the diet, DNA and cell mitochondrial damage can occur, Bruce N. Ames, Supplements and Tuning Up Metabolism 1-3, 134 American Soc. Nutritional Sci. J. Nutr. 3164S-3168S (2004), leading to a number of chronic problems.

Research shows that ionic trace minerals are a superior source. Ionic minerals are electrically charged, making them more available by allowing them to penetrate the cell membranes of the body. Ionic minerals are in a form that allows the body to recognize and utilize them most efficiently.

While prior nutritional supplement products are known and are generally suitable for their limited purposes, they possess certain inherent deficiencies that detract from their overall utility in supplementing the diets of men and women, respectively. For example, nutritional supplement drinks have suffered from precipitation of the minerals from solution. Further, there has been a problem with the preservation of the nutritional supplement drinks, that is, they have tended to degrade in storage. Moreover, there has been a problem with flavor in that nutritional supplement drinks tend to be unappetizing because of the unappealing taste of combinations of vitamins and minerals

In view of the foregoing, it will be appreciated that providing dietary supplements that contain gender-specific herbal nutrients and also containing vitamins and minerals would be a significant advancement in the art. In particular, such dietary supplements that solve the problems of precipitation, stability, and flavor would meet long-felt needs that have previously gone unresolved.

### BRIEF SUMMARY OF THE INVENTION

It is an illustrative feature of the present invention to provide gender-specific herbal nutritional supplement drinks that also contain vitamins and minerals and solve the problems of solubility, stability, and flavor that have plagued prior supplement drinks.

An illustrative nutritional drink composition according to the present invention comprises maca extract and water. This composition can further comprise vitamins, minerals, or flavors, and mixtures thereof.

Another illustrative nutritional drink composition according to the present invention comprises vitex extract and water. This composition can also further comprise vitamins, minerals, or flavors, and mixtures thereof.

Still another illustrative nutritional drink composition according to the present invention comprises about 74.20-82.47% by weight of water, about 15-20% by weight of flavors, about 2.0-3.0% by weight of minerals, about 0.5-2.5% by weight of maca extract, about 0.02-0.2% by weight of preservatives, and about 0.01-0.1% by weight of vitamins.

Yet another nutritional drink composition according to the present invention comprises about 74.100-80.959% by weight of water, about 17-22% by weight of flavors, about 2.0-3.0% by weight of minerals, about 0.02-0.2% by weight of preservatives, and about 0.01-0.1% by weight of vitamins, about 0.01-0.5% by weight of thickeners, and about 0.001-0.1% by weight of vitex extract.

### DETAILED DESCRIPTION

Before the present gender-specific trace mineral-containing compositions are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

The publications and other reference materials referred to herein to describe the background of the invention and to provide additional detail regarding its practice are hereby incorporated by reference. The references discussed herein are provided solely for their disclosure prior to the filing date of the present application. Nothing herein is to be construed as an admission that the inventors are not entitled to antedate such disclosure by virtue of prior invention.

It must be noted that, as used in this specification and the appended claims, the singular forms “a,” “an,” and “the” include plural referents unless the context clearly dictates otherwise.

Unless defined otherwise, all technical and scientific terms used herein have the same meanings as commonly understood by one of ordinary skill in the art to which this invention belongs.

In describing and claiming the present invention, the following terminology will be used in accordance with the definitions set out below.

As used herein, “comprising,” “including,” “containing,” “characterized by,” and grammatical equivalents thereof are inclusive or open-ended terms that do not exclude additional, unrecited elements or method steps. “Comprising” is to be interpreted as including the more restrictive terms “consisting of” and “consisting essentially of.” As used herein, “consisting of” and grammatical equivalents thereof exclude any element, step, or ingredient not specified in the claim. As used herein, “consisting essentially of” and grammatical equivalents thereof limit the scope of a claim to the specified materials or steps and those that do not materially affect the basic and novel characteristic or characteristics of the claimed invention.

As used herein, “sterilizing” and similar terms means, with respect to nutritional supplements having a pH less than 4.6 and a water activity greater than 0.85, pasteurizing the nutritional supplement and storing at room temperature. With respect to nutritional supplements having a pH greater than 4.6 and a water activity greater than 0.85, “sterilizing” and similar terms mean applying heat such that the nutritional supplement is rendered free of microorganisms capable of reproducing in the nutritional supplement under normal non-refrigerated conditions of storage and distribution.

As used herein, “pasteurization” traditionally means a process named after scientist Louis Pasteur by which every particle of milk is heated to not lower than 62.8° C. (i.e., 145° F.) for not less than 30 minutes and promptly cooled to destroy any harmful bacteria that may be present without affecting flavor and food value. Currently, the most common method of pasteurization in the United States is High Temperature Short Time (HTST) pasteurization, which uses metal plates and hot water to raise temperatures to 71.7° C. (i.e., 161° F.) for not less than 15 seconds, followed by rapid cooling. Ultra Pasteurization (UP) is a process similar to HTST pasteurization, but using higher temperatures and longer times. UP pasteurization results in a product with longer shelf life but still requiring refrigeration of milk, but not of acidified foods or nutritional supplements (pH<4.6). Another method, Ultra High Temperature (UHT) pasteurization, raises the temperature to over 93.3° C. (i.e., 200° F.) for a few seconds, followed by rapid cooling. A UHT-pasteurized product that is packaged aseptically results in a “shelf stable” product that does not require refrigeration until it is opened.

As used herein, “aseptic processing and packaging” and similar terms mean the filling of a sterilized cooled product into pre-sterilized containers, followed by aseptic hermetic sealing, with a pre-sterilized closure, in an atmosphere free of microorganisms.

As used herein, “hermetically sealed container” and similar terms mean a container that is designed and intended to be secure against the entry of microorganisms and thereby to maintain the sterility of its contents after processing.

The nutritional supplement drinks of the present invention provide gender-specific or gender-targeted drinks for supplementing the respective diets of men and women. In addition, much experimentation has been necessary to solve the problems of precipitation of minerals, stability of the drinks during storage, and acceptable flavor to consumers. The precipitation problem has been solved by careful adjustment of concentrations of the various minerals and vitamins, along with adjustment of the pH. The stability problem has similarly been solved by pH adjustment and addition of appropriate preservatives. Finally, the flavor problem has been solved by experimentation with natural flavors and fruit concentrates and selection of such flavoring agents and their concentrations.

### Male-Specific Nutrients

Maca (Lepidium meyenii) is an herbaceous biennial or annual plant, although some sources say a perennial plant) native to the high Andes of Bolivia and Peru. It is grown for its fleshy hypocotyl (actually a fused hypocotyl and taproot), which is used as a root vegetable and a medicinal herb. Its Spanish and Quechua names include maca-maca, maino, ayak chichira, and ayak willku. For about 2000 years maca has been an important traditional food and medicinal plant in its growing region. It is regarded as a highly nutritious food and as a medicine that enhances strength and endurance. It is also reported to act as an aphrodisiac. It is specifically known to be advantageous for men. During the Spanish colonial era, maca was used as currency.

The growth habit, size, and proportions of the maca are roughly similar to those of the radish and the turnip, to which it is related. The stem is short and lies along the ground, with only the tip curling up. Reproduction is through seeds. Maca is the only member of its genus with a fleshy hypocotyl. Maca is traditionally grown at altitudes of about 3,750-4,350 meters. It grows well only in very cold climates and relatively poor soils. Although it has been cultivated outside the Andes, it is not yet clear that it has the same constituents or potency when so grown. Hypocotyls do not form in greenhouses or in warm climates.

In addition to sugars and proteins, maca contains uridine, malic acid and benzoyl derivatives thereof, and the glucosinolates, glucotropaeolin and m-methoxyglucotropaelin. The methanol extract of maca tuber also contains (1R,3S)-1-methyltetrahydro-carboline-3-carboxylic acid, which is reported to exert many activities on the central nervous system. The nutritional value of dried maca root is high, similar to cereal grains such as rice and wheat. It contains 60% carbohydrates, 10% protein, 8.5% dietary fiber, and 2.2% fat. Maca is rich in essential minerals, especially selenium, calcium, magnesium, and iron. It also includes linolenic acid, palmitic acid, and oleic acid; 19 amino acids; and polysaccharides.

In Peru, maca is prepared in several ways. The hypocotyl can be roasted in a pit (called matia). The root can also be mashed and boiled to produce a sweet, thick liquid; dried and mixed with milk to form a porridge; or mixed with vegetables or grains to produce a flour that can be used in baking. If fermented, a weak beer called chic ha de maca can be made. The leaves can also be prepared raw in salads or cooked much like garden cress (Lepidium sativum) and field pepperweed (Lepidium campestre). Maca extract is commercially available.

### Female-Specific Nutrients

Vitex (Vitex agnus-castus), also known as chaste tree, chasteberry, or monk's pepper, can be used as a hormonal tonic for women. Vitex stimulates and normalizes the pituitary gland, which regulates the balance of estrogen and progesterone in the body. In a normal menstrual cycle, estrogen is higher before ovulation and progesterone is higher after. Vitex usually has the effect of enhancing progesterone levels and decreasing estrogen levels. Almost all of the symptoms associated with the menstrual cycle can be treated with vitex. Thus, it can be used for treating cramps, flooding, headaches, depression, water retention, constipation, acne, breast tenderness, and irritability. It can also help normalize irregular or scanty periods. It may be especially helpful for women who have stopped using birth control pills. For many women, cycles remain irregular for up to two years after stopping the pill. Vitex can greatly shorten that time and helps ease the body into regaining its own natural rhythm.

Vitex may be used for enhancing the chances of conception through its ability to regulate ovulation. If taken through the first trimester of pregnancy, vitex reduces the chances of miscarriage. After delivery, it helps a new mother with lactation.

Vitex also offers many benefits to women who are menopausal. It helps to relieve many of the uncomfortable symptoms including hot flashes, irregular cycles, depression, and flooding. Vitex is also known as a remedy for women with uterine fibroids, fibrocystic breasts, and endometriosis. All of these conditions proliferate under the influence of estrogen and shrink under the influence of progesterone.

Vitex extract can be made by extraction of ripe berries with an aqueous or ethanolic solvent.

### Minerals

Minerals serve a wide variety of essential physiological functions ranging from structural components of body tissues to essential components of many enzymes and other biological important molecules. Minerals are classified as micronutrients or trace elements on the basis of the amount present in the body. The seven micronutrients (calcium, potassium, sodium, magnesium, phosphorus, sulfur, and chloride) are present in the body in quantities of more than five grams. Trace elements, which include boron, copper, iron, manganese, selenium, and zinc are found in the body in quantities of less than five grams.

Micronutrient Minerals. Calcium is the mineral element believed to be most deficient in the diet in the United States. Calcium intakes in excess of 300 mg per day are difficult to achieve in the absence of milk and dairy products in the diet. This is far below the recommended dietary allowance (RDA) for calcium (1000 mg per day for adults and children ages one to ten, 1200 mg per day for adolescents and pregnant and lactating women, which equates to about four glasses of milk per day). In fact, it has been reported that the mean daily calcium intake for females over age 12 does not exceed 85 percent of the RDA. In addition, during the years of peak bone mass development (18 to 30), more than 66 percent of all U.S. women fail to consume the recommended amounts of calcium on any given day. After age 35, this percentage increases to over 75 percent.

Although the general public is not fully aware of the consequences of inadequate mineral intake over prolonged periods of time, there is considerable scientific evidence that low calcium intake is one of several contributing factors leading to osteoporosis. In addition, the dietary ratio of calcium to phosphorous (Ca:P) relates directly to bone health. A Ca to P ratio of 1:1 to 2:1 is recommended to enhance bone marrowization in humans. Such ratios are difficult to achieve absent an adequate dietary supply of milk and dairy products, or an adequate supply of calcium and other minerals for the lactose-intolerant segment of the population.

Magnesium is the second most plentiful cation of the intracellular fluids. It is essential for the activity of many enzyme systems and plays an important role with regard to neurochemical transmission and muscular excitability. Deficits are accompanied by a variety of structural and functional disturbances. The average 70-kg adult has about 2000 mEq of magnesium in his body. About 50% of this magnesium is found in bone, 45% exists as an intracellular cation, and 5% is in the extracellular fluid. About 30% of the magnesium in the skeleton represents an exchangeable pool present either within the hydration shell or on the crystal surface. Mobilization of the cation from this pool in bone is fairly rapid in children, but not in adults. The larger fraction of magnesium in bone is apparently an integral part of bone crystal.

The average adult in the United States ingests about 20 to 40 mEq of magnesium per day in an ordinary diet, and of this about one third is absorbed from the gastrointestinal tract. The evidence suggests that the bulk of the absorption occurs in the upper small bowel. Absorption is by means of an active process apparently closely related to the transport system for calcium. Ingestion of low amounts of magnesium results in increased absorption of calcium and vice versa.

Magnesium is a cofactor of all enzymes involved in phosphate transfer reactions that utilize adenosine triphosphate (ATP) and other nucleotide triphosphates as substrates. Various phosphatases and pyrophosphatases also represent enzymes from an enormous list that are influenced by this metallic ion.

Magnesium plays a vital role in the reversible association of intracellular particles and in the binding of macromolecules to subcellular organelles. For example, the binding of messenger RNA (mRNA) to ribosomes is magnesium dependent, as is the functional integrity of ribosomal subunits. Certain of the effects of magnesium on the nervous system are similar to those of calcium. An increased concentration of magnesium in the extracellular fluid causes depression of the central nervous system (CNS). Hypomagnesemia causes increased CNS irritability, disorientation, and convulsions. Magnesium also has a direct depressant effect on skeletal muscle. Abnormally low concentrations of magnesium in the extracellular fluid result in increased acetylcholine release and increased muscle excitability that can produce tetany.

Trace Minerals. Chromium is an important trace element wherein the lack of sufficient chromium in the diet leads to impairment of glucose utilization, however, disturbances in protein and lipid metabolism have also been observed. Impaired glucose utilization occurs in many middle-aged and elderly human beings. In experimental studies, significant numbers of such persons have shown improvement in their glucose utilization after treatment with chromium. Chromium is transported by transferrin in the plasma and competes with iron for binding sites. Chromium as a dietary supplement may produce benefits due to its enhancement of glucose utilization and its possible facilitating the binding of insulin to insulin receptors, which increases its effects on carbohydrate and lipid metabolism. Chromium as a supplement may produce benefits in atherosclerosis, diabetes, rheumatism, and weight control.

Copper is another important trace element in the diet. The most common defect observed in copper-deficient animals is anemia. Other abnormalities include growth depression, skeletal defects, demyelination and degeneration of the nervous system, ataxia, defects in pigmentation and structure of hair or wool, reproductive failure and cardiovascular lesions, including dissecting aneurisms. Several copper-containing metalloproteins have been isolated, including tyrosinase, ascorbic acid oxidase, laccase, cytochrome oxidase, uricase, monoamine oxidase, 6-aminolevulinic acid hydrydase, and dopamine-p-hydroxylase. Copper functions in the absorption and utilization of iron, electron transport, connective tissue metabolism, phospholipid formation, purine metabolism, and development of the nervous system. Ferroxidase I (ceruloplasmin), a copper-containing enzyme, effects the oxidation of Fe(II) to Fe(III), a required step for mobilization of stored iron. A copper-containing enzyme is thought to be responsible for the oxidative deamination of the epsilon amino group of lysine to produce desmosine and isodesmosine, the cross-links of elastin. In copper-deficient animals the arterial elastin is weaker and dissecting aneurisms may occur.

Iodine is important for the production of thyroid hormones, which regulate cellular oxidation. The iodine-deficiency disease is goiter. In iodine-deficient young, growth is depressed and sexual development is delayed, the skin and hair are typically rough, and the hair becomes thin. Cretinism, feeble-mindedness, and deaf-mutism occur in a severe deficiency. There is reproductive failure in females and decreased fertility in males that lack sufficient iodine in the diet.

Manganese plays a role in the synthesis of GAGs, collagen, and glycoproteins, which are important constituents of cartilage and bone. Manganese is required for enzyme activity of glycosyltransferases. This family of enzymes is responsible for linking sugars together into GAGs, adding sugars to other glycoproteins, adding sulfate to aminosugars, converting sugars to other modified sugars, and adding sugars to lipids. These functions are manifested as GAG synthesis (hyaluronic acid, chondroitin sulfate, karatan sulfate, heparin sulfate, and dermatin sulfate, among others), collagen synthesis, and function of many other glycoproteins and glycolipids. GAGs and collagen are chief structural elements for all connective tissues. Their synthesis is essential for proper maintenance and repair of connective tissues.

Manganese deficiencies in humans and animals lead to abnormal bone growth, swollen and enlarged joints, and slipped tendons. In humans, manganese deficiencies are associated with bone loss, arthritis, and impaired glucose utilization. Levels of all GAGs are decreased in connective tissues during manganese deficiencies, with chondroitin sulfates being most depleted. Manganese-deficient organisms quickly normalize GAG and collagen synthesis when manganese is provided.

Manganese is also required for activity of manganese superoxide dismutase (MnSOD), which is present only in mitochondria. Manganese deficiency decreases the activity of MnSOD and may lead to mitochondrial dysfunction, manifested as decreased cellular functions. Manganese is required for the conversion of mevalonic acid to squalene. Pyruvate carboxylase is a manganese metalloenzyme, repressible by insulin, important in the citric acid cycle for the oxidation of carbohydrates, lipids, and proteins, as well as in the synthesis of glucose and lipids.

Molybdenum is an essential mineral found in highest concentrations in the liver, kidneys, skin, and bones. This mineral is required by the body to properly metabolize nitrogen. It is also a vital component of the enzyme xanthine oxidase, which is required to convert purines to uric acid, a normal byproduct of metabolism. Molybdenum also supports the body's storage of iron and other cellular functions such as growth. A deficiency of molybdenum is associated with mouth and gum disorders and cancer. A diet high in refined and processed foods can lead to a deficiency of molybdenum, resulting in anemia, loss of appetite and weight, and stunted growth in animals. While these deficiencies have not been observed directly in humans, it is known that a molybdenum deficiency can lead to impotence in older males.

Selenium is an essential trace element that functions as a component of enzymes involved in protection against antioxidants and thyroid hormone metabolism. In several intra- and extra-cellular glutathione peroxidases and iodothyronine 5′-deiodinases, selenium is located at the active centers as the selenoamino acid, selenocysteine (SeCYS). At least two other proteins of unknown function also contain SeCYS. Although SeCYS is an important dietary form, it is not directly incorporated into these specific selenium-proteins; instead, a co-translational process yields tRNA-bound SeCYS. In contrast, selenium as seleno-methionine is incorporated non-specifically into many proteins, as it competes with methionine in general protein synthesis. Therefore, tissues often contain both specific, as well as the nonspecific, selenium-containing proteins when both SeCYS and selenomethionine are consumed, as found in many foods. Selenium is a major antioxidant nutrient and is involved in protecting cell membranes and preventing free radical generation, thereby decreasing the risk of cancer and disease of the heart and blood vessels. Medical surveys show that increased selenium intake decreases the risk of breast, colon, lung and prostate cancer. Selenium also preserves tissue elasticity; slows down the aging and hardening of tissues through oxidation; and helps in the treatment and prevention of dandruff. Recent research has shown antitumorigenic effects of high levels of selenium in the diets of several animal models.

Zinc is known to occur in many important metalloenzymes. These include carbonic anhydrase, carboxypeptidases A and B, alcohol dehydrogenase, glutamic dehydrogenase, D-glyceraldehyde-3-phosphate dehydrogenase, lactic dehydrogenase, malic dehydrogenase, alkaline phosphatase, and aldolase. Impaired synthesis of nucleic acids and proteins has been observed in zinc deficiency. There is also evidence that zinc may be involved in the secretion of insulin and in the function of the hormone.

According to the present invention, minerals can be provided as inorganic compounds, such as chlorides, sulfates, and the like. In addition, some minerals can be provided in more bioavailable forms, such as amino acid chelates, which are well known in the art. U.S. Pat. No. 5,292,538. Examples of minerals that can be provided as amino acid chelates include calcium, magnesium, manganese, zinc, copper, molybdenum, and chromium. Still further, minerals can be provided as deep sea minerals.

While trace minerals are needed only in very small amounts, they are essential for optimal metabolism. They often function in the body as coenzymes. That is, they work with enzymes to speed up chemical reactions in the body. Trace minerals are essential for proper energy and well being.

There are over 90 elements found in nature, and any one of them could play an as yet undiscovered role in human health. Keeping the level of minerals in balance in the human body may be a key to maintaining human health. In an illustrative embodiment of the present invention there is provided a balance of minerals and trace minerals that is similar to that of sea water and also to healthy blood plasma.

Minerals are best absorbed in the body in an ionic form be cause ionic minerals are easily transported across cell membranes of the digestive tract. Thus, an illustrative embodiment of the present invention provides minerals in ionic form.

In an illustrative embodiment of the present invention there is provided a trace mineral concentrate obtained from the Great Salt Lake of Utah. Water is gathered from the lake, then the water is concentrated into a brine and the brine is evaporated and the sodium ion concentration is reduced. This concentrate is uniquely low in certain toxic heavy metals. The reason for this is the heavy metals in the Great Salt Lake precipitate, along with clays, organic matter, and carbonates, to the sediments and deep brines where anaerobic conditions and sulfides formed by sulfate reducing bacteria immobilize the metals. The lake thus avoids accumulation of heavy metals in the lake water, thus the lake is non-toxic and self-cleansing. The unique saline conditions of the Great Salt Lake determine the precipitation and immobilization of heavy metals in the lake. Minerals and ions verified to be contained in the concentrate in trace amounts in the following approximate descending order: chloride, magnesium, sulfate, potassium, sodium, bromide, lithium, boron, carbonate, calcium, fluoride, silicon, nitrogen, selenium, phosphorus, iodide, chromium, iron, manganese, titanium, rubidium, cobalt, copper, antimony, arsenic, molybdenum, strontium, zinc, nickel, tungsten, germanium, aluminum, scandium, vanadium, tellurium, barium, tin, lanthanum, lead, yttrium, silver, cadmium, uranium, gallium, bismuth, zirconium, cerium, cesium, gold, beryllium, hafnium, samarium, terbium, europium, gadolinium, mercury, dysprosium, thorium, holmium, lutetium, thulium, erbium, ytterbium, neodymium, praseodymium, niobium, tantalum, thallium, rhenium, indium, palladium, platinum, osmium, ruthenium, rhodium, iridium. In addition, the noble gases, helium, neon, argon, krypton, xenon, and radon, are believed to be present, since these gases are present in sea water, although they have not been tested for. On average, chloride is present at about 280-350 mg/ml, magnesium at about 100-110 mg/ml, sulfate at about 15-25 mg/ml, sodium at less than about 2.5 mg/ml, and potassium at about 0.65-2.5 mg/ml. Total heavy metals are present at less than 5 ppm, and lead and mercury are present at less than 0.3 ppm and 0.1 ppm, respectively. In addition, aluminum, arsenic, and cadmium are present at less than 1 ppm, 1 ppm, and 0.5 ppm, respectively.

Further, fulvic acid mineral water may be provided as an additional source of minerals. Fulvic acid mineral water is made from three different ores and a blend of those ores is used to produce humic acid and fulvic acid. The humic acid is separated from the fulvic acid, leaving a smooth tasting mineral water that contains numerous minerals that are chelated by the fulvic acid. In addition to the minerals, this fulvic acid mineral water also contains antioxidants, amino acids, and polyelectrolytes.

### Vitamins

Vitamins are organic compounds that are required for the normal growth and maintenance of life of animals, including man, who are generally unable to synthesize these compounds by anabolic processes that are independent of environment other than air, and which compounds are effective in small amounts, do not furnish energy, and are not utilized as building units for the structure of the organism, but are essential for the transformation of energy and for the regulation of the metabolism of structural units. Vitamins or their precursors are found in plants, and thus plant tissues are the sources for the animal kingdom of these protective nutritional factors. In addition to carbohydrates, fats, proteins, mineral salts, and water, it is essential that the food of man and animals contain small amounts of these vitamins. If any one of at least 13 of these compounds is lacking in the diet, a breakdown of the normal metabolic processes occurs, which results in a reduced rate or complete lack of growth in children and in symptoms of malnutrition that are classified as deficiency diseases.

The functions of vitamins generally fall into two categories, the maintenance of normal structure and the maintenance of normal metabolic functions. For example, thiamine, riboflavin, pantothenic acid, and niacin, are known to be essential constituents of the respiratory enzymes that are required in the utilization of energy from oxidative catabolism of sugars and fats.

Biotin functions in synthesis and breakdown of fatty acids and amino acids through aiding the addition and removal of carbon dioxide to or from active compounds. It similarly acts in catalyzing deamination of amino acids and in oleic acid synthesis. Biotin is also an essential component of enzymes and aids in the utilization of protein and certain other vitamins, such as folic acid, pantothenic acid, and vitamin B-12.

Folic acid or folacin is one of the important hematopoietic agents necessary for proper regeneration of blood-forming elements and their functioning. Folic acid is also involved as a coenzyme in intermediary metabolic reactions in which one-carbon units are transferred. These reactions are important in interconversions of various amino acids and in purine and pyrimidine synthesis. The biosynthesis of purines and pyrimidines is ultimately linked with that of nucleotides and ribo- and deoxyribo-nucleic acids, functional elements in all cells.

Niacin (nicotinic acid) and niacinamide (nicotinamide) have identical properties as vitamins. In the body niacin is converted to niacinamide, which is an essential constituent of coenzymes I and II that occur in a wide variety of enzyme systems involved in anaerobic oxidation of carbohydrates. The coenzyme serves as a hydrogen acceptor in the oxidation of the substrate. These enzymes are present in all living cells and take part in many reactions of biological oxidation. Nicotinamide-adenine dinucleotide (NAD) and nicotinamide-adenine dinucleotide phosphate (NADP) are coenzymes synthesized in the body that take part in the metabolism of all living cells. Since they are of such widespread and vital importance, it is not difficult to see why serious disturbance of metabolic processes occurs when the supply of niacin to the cell is interrupted. Niacin is readily absorbed from the intestinal tract, and large doses may be given orally or parenterally with equal effect. Further, niacin improves circulation and reduces the cholesterol level in the blood; maintains the nervous system; helps metabolize protein, sugar & fat; reduces high blood pressure; increases energy through proper utilization of food; prevents pellagra; and helps maintain a healthy skin, tongue, and digestive system.

Pantothenic acid is of the highest biological importance because of its incorporation into Coenzyme A (CoA), which is involved in many vital enzymatic reactions transferring a two-carbon compound (the acetyl group) in intermediary metabolism. It is involved in the release of energy from carbohydrate and protein, in the degradation and metabolism of fatty acids, and in the synthesis of such compounds as sterols and steroid hormones, porphyrins, and acetyl-choline. Pantothenic acid also participates in the utilization of vitamins; improves the body's resistance to stress; helps in cell building & the development of the central nervous system; helps the adrenal glands, and fights infections by participating in building of antibodies.

Pyridoxine (vitamin B-6) does not denote a single substance, but is rather a collective term for a group of naturally occurring pyridines that are metabolically and functionally interrelated: namely, pyridoxine, pyridoxal, and pyridoxamine. They are interconvertible in vivo in their phosphorylated form. Vitamin B-6 in the form of pyridoxal phosphate or pyridoxamine phosphate functions in carbohydrate, fat, and protein metabolism. Its major functions are most closely related to protein and amino acid metabolism. The vitamin is a part of the molecular configuration of many enzymes (a coenzyme), notably glycogen phosphorylase, various transaminases, decarboxylases, and deaminases. The latter three are essential for the anabolism and catabolism of proteins. Pyridoxine is also aids in fat and carbohydrate metabolism; aids in the formation of antibodies; maintains the central nervous system; aids in the removal of excess fluid of premenstrual women; promotes healthy skin; reduces muscle spasms, leg cramps, hand numbness, nausea and stiffness of hands; and helps maintain a proper balance of sodium and phosphorous in the body.

Riboflavin is another B vitamin, which plays its physiological role as the prosthetic group of a number of enzyme systems that are involved in the oxidation of carbohydrates and amino acids. It functions in combination with a specific protein either as a mononucleotide containing phosphoric acid (FMN), or as a dinucleotide combined through phosphoric acid with adenine (FAD). The specificity of each of the enzymes is determined by the protein in the complex. By a process of oxidation-reduction, riboflavin in the system either gains or loses hydrogen. The substrate, either carbohydrate or amino acid, may be oxidized by a removal of hydrogen. The first hydrogen acceptor in the chain of events is NAD or NADP, the di- or tri-nucleotide containing nicotinic acid and adenine. The oxidized riboflavin system then serves as hydrogen acceptor for the coenzyme system and in turn is oxidized by the cytochrome system. The hydrogen is finally passed on to the oxygen to complete the oxidative cycle. A number of flavoprotein enzymes have been identified, each of which is specific for a given substrate. Riboflavin also aids in the formation of antibodies and red blood cells; maintains cell respiration; necessary for the maintenance of good vision, skin, nails and hair; alleviates eye fatigue; and promotes general health.

Thiamine or thiamin is a generic term applied to all substances possessing vitamin B-1 activity, regardless of the anion attached to the molecule. The cationic portion of the molecule is made up of a substituted pyrimidine ring connected by a methylene bridge to the nitrogen of a substituted thiazole ring. In a phosphorylated form, thiamine serves as the prosthetic group of enzyme systems that are concerned with the decarboxylation of α-ketoacids. Some decarboxylation reactions are reversible, so that synthesis (condensation) may be achieved. Thus, thiamine is also important to the biosynthesis of keto-acids. It is involved in transketolase reactions. Thiamine is readily absorbed in aqueous solution from both the small and large intestine, and is then carried to the liver by the portal circulation. In the liver, as well as in all living cells, it normally combines with phosphate to form cocarboxylase. It may be stored in the liver in this form or it may combine further with manganese and specific proteins to become active enzymes known as carboxylases. Thiamine also plays a key role in the body's metabolic cycle for generating energy; aids in the digestion of carbohydrates; is essential for the normal functioning of the nervous system, muscles & heart; stabilizes the appetite; and promotes growth & good muscle tone.

Vitamin B-12 or cyanocobalamin is essential for the functioning of all cells, but particularly for cells of the bone marrow, the nervous system, and the gastrointestinal tract. It appears to facilitate reduction reactions and participate in the transfer of methyl groups. Its chief importance seems to be, together with folic acid, in the anabolism of DNA in all cells. It is a requisite for normal blood formation, and certain macrocystic anemias respond to its administration. Vitamin B-12 is also necessary for carbohydrate, fat, and protein metabolism; maintains a healthy nervous system; promotes growth in children; increases energy; and is needed for calcium absorption.

### Flavors

A variety of natural flavors may be used according to the present invention to provide an acceptable taste for consumers and to mask the taste of certain of the vitamins, minerals, and herbal ingredients. Illustrative of such flavors are agave concentrate, black currant juice concentrate and/or powder, cane sugar, grape flavor, bitterness and acidity suppressor flavor powder (Bell Flavors & Fragrances, Inc., Northbrook, Ill.), oligofructose and fructose (CitriSweetM, Roxlor International LLC, Wilmington, Del.), citric acid, malic acid, luo han guo (also known as momordica), high fructose corn syrup, sea buckthorn puree, pineapple concentrate, pear concentrate, and purple granadilla concentrate. These flavoring agents, when selected in appropriate combinations and amounts are helpful in adjusting the pH of the drinks, in providing tartness, and in providing good-tasting flavors that mask the unappealing tastes of other ingredients.

Some of these flavor ingredients possess a high oxygen radical absorbance capacity (ORAC). As used herein, “high ORAC value” or similar terms means an ORAC value of at least about 400 per 100 grams of fruit or vegetable. For example, blueberries have an ORAC value of about 2,400 per 100 grams, and the following fruits have ORAC values as shown in parentheses per 100 grams: blackberries (2,036), cranberries (1,750), strawberries (1,540), raspberries (1,220), plums (949), oranges (750), red grapes (739) cherries (670), kiwi fruit (602), and white grapes (446). Other fruits known to have a high ORAC value include black grapes, mangosteen, noni, aronia, wolfberry, and acai, and the like.

Free radicals are very reactive and highly destructive compounds in the body. Free radicals are products of oxidative deterioration of such substances as polyunsaturated fat. Antioxidants convert free radical into a less reactive and nonharmful chemical form. Flavors with high ORAC value have antioxidant activity.

### Thickeners

Certain illustrative embodiments of the invention also contain thickeners for giving the drink an increase of viscosity. Illustrative of these thickeners are xanthan gum and Irish moss.

### Preservatives

Preservatives, such as sodium benzoate, potassium sorbate, and methylparaben may also be included. These preservatives, together with appropriate pH adjustment, help to maintain the stability of the drinks during storage.

### Water

Substantially pure water, such as deionized water or reverse osmosis (RO) water, is also an important ingredient of the liquid mixture.

### Preparation of the Composition

The various minerals, vitamins, flavors, other ingredients, and water are mixed together in amounts that provide the desired amount of dietary supplementation when consumed while maintaining solubility of the ingredients and preserving shelf life during storage. Next, the mixture is sterilized by pasteurization or other heating techniques. Although pasteurization (at least 87.8° C. or 190° F.) effectively eliminates pathogenic microorganisms, sterilization at higher temperatures maybe needed to eliminate all microorganisms.

In achieving the necessary sterilization, two different sterilization processes are typically used. Using the HTST (high temperature short time) process, the mixture may be raised to about 85° C. (185° F.) for about 20-30 seconds. Alternately, the ultra-high temperature (UHT) process involves raising the temperature of the mixture to about 140.6° C. (285° F.) for about 4-6 seconds. In either process, immediately after the heating step, the temperature is rapidly lowered to at least ambient temperatures of about 21.1-26.7° C. (70-80° F.). Alternately, the mixture may be chilled down to about 4.4° C. (40° F.).

Heating of the mixture may be accomplished by direct or indirect heating. For example, the mixture may be heated by direct contact with steam or indirectly by a selected type of heat exchanger.

The sterilized blend may then be poured into containers, using a hot-fill or cold-fill method. In the hot-fill process, the product is first heated to temperatures for pasteurization, HTST, or UHT. Then it is poured into containers at elevated temperatures to kill any microorganisms inside the container. The use of preservatives, such as sodium benzoate and potassium sorbate are normally used. The pH is usually maintained below 4.4. After filling, the bottles may be cooled slowly by a water mist. Filling of containers is done by aseptic processing and packaging methods, which are well known in the art.

In the cold-fill process, after pasteurization or sterilization temperatures are reached, the product is immediately cooled to about room temperature prior to bottling, using aseptic processing and packaging techniques. Immediate cooling allows less vitamin degradation and variations in flavor that may be found in the hot-fill process. Thus, in cold-fill processing the flavor may be cleaner and fresher. Preservatives are usually included to control the growth of yeast, molds, and bacteria.

The cold-fill process is compatible with use of high-density polyethylene (HDPE) or polyethylene terephthalate (PET) bottling, so as to not compromise the integrity of the bottle structure.

### EXAMPLE 1

A gender-specific drink composition for males according to the present invention generally comprises about 74.20-82.47% by weight of water, about 15-20% by weight of flavors, about 2.0-3.0% by weight of minerals, about 0.5-2.5% by weight of maca, about 0.02-0.2% by weight of preservatives, and about 0.01-0.1% by weight of vitamins.

### EXAMPLE 2

A gender-specific drink composition for males according to the present invention comprises 75.1299% by weight of water, 19.4763% by weight of flavors, 2.9688% by weight of minerals, 2.2500% by weight of maca, 0.0800% by weight of potassium sorbate as a preservative, and 0.0950% by weight of vitamins.

### EXAMPLE 3

A gender-specific drink composition for males according to the present invention comprises 82.1280% by weight of water, 15.2320% by weight of flavors, 2.0000% by weight of minerals, 0.6000% by weight of maca, 0.0300% by weight of potassium sorbate as a preservative, and 0.0100% by weight of vitamins.

### EXAMPLE 4

A gender-specific drink composition for males according to the present invention comprises ingredients as set out as follows in % by weight:
78.3652% water
8.4746% agave concentrate
3.1400% black currant concentrate
2.8249% cane sugar
2.1670% of a micromineral blend comprising 50 mg calcium lactate, 20 mg magnesium sulfate, 0.75 mg zinc gluconate, 0.2 mg manganese sulfate, 0.2 mg copper gluconate, 94 μg sodium molybdate, 90 μg chromium chloride, 53 μg sodium selenate, 75 μg potassium iodide
1.8600% of black currant powder
1.2500% of maca root extract
0.5646% of natural flavors comprising grape flavor and bitter and acidity suppressing powder
0.4708% oligofructose and fructose
0.3000% of trace mineral concentrate
0.1412% citric acid
0.1412% malic acid
0.1000% of fulvic acid mineral water
0.0940% of luo han guo extract
0.0600% of sodium benzoate
0.0135% of biotin
0.0131% of niacinamide
0.0083% of pantothenic acid
0.0049% of pyridoxine HCl
0.0023% of riboflavin
0.0021% of thiamine HCl
0.0019% of vitamin B12
0.0004% of folic acid

### EXAMPLE 5

A gender-specific drink composition for females according to the present invention generally comprises about 74.100-80.959% by weight of water, about 17-22% by weight of flavors, about 2.0-3.0% by weight of minerals, about 0.02-0.2% by weight of preservatives, and about 0.01-0.1% by weight of vitamins, about 0.01-0.5% by weight of thickeners, and about 0.001-0.1% by weight of vitex extract.

### EXAMPLE 6

A gender-specific drink composition for females according to the present invention comprises 75.5775% by weight of water, 21.1250% by weight of flavors, 2.8575% by weight of minerals, 0.2000% by weight of a preservative, 0.1000% by weight of vitamins, 0.0400% by weight of thickeners, and 0.1000% by weight of vitex extract.

### EXAMPLE 7

A gender-specific drink composition for females according to the present invention comprises 82.1315% by weight of water, 15.4422% by weight of flavors, 2.3843% by weight of minerals, 0.0200% by weight of a preservative, 0.0100% by weight of vitamins, 0.0100% by weight of thickeners, and 0.0020% by weight of vitex extract.

### EXAMPLE 8

A gender-specific drink composition for females according to the present invention comprises ingredients as set out as follows in % by weight:
77.6255% water
5.0000% high fructose corn syrup
5.000% sea buckthorn fruit puree
4.0000% pineapple fruit concentrate
2.5000% pear fruit concentrate
2.5000% purple granadilla fruit concentrate
2.1670% of a micromineral blend comprising 50 mg calcium lactate, 20 mg magnesium sulfate, 0.75 mg zinc gluconate, 0.2 mg manganese sulfate, 0.2 mg copper gluconate, 94 μg sodium molybdate, 90 μg chromium chloride, 53 μg sodium selenate, 75 μg potassium iodide
0.6000% oligofructose and fructose
0.3000% of trace mineral concentrate
0.1000% of fulvic acid mineral water
0.0600% of sodium benzoate
0.0400% of luo han guo extract
0.0400% xanthan gum
0.0135% of biotin
0.0131% of niacinamide
0.0100% chaste tree fruit extract
0.0100% Irish moss
0.0083% of calcium D-pantothenate
0.0049% of pyridoxine HCl
0.0033% of riboflavin
0.0021% of thiamine HCl
0.0019% of vitamin B12
0.0004% of folic acid

The subject matter claimed is:

1. A nutritional drink composition comprising maca extract and water.

2. The composition of claim 1 further comprising vitamins.

3. The composition of claim 1 further comprising minerals.

4. A nutritional drink composition comprising vitex extract and water.

5. The composition of claim 4 further comprising vitamins.

6. The composition of claim 4 further comprising minerals.

7. A nutritional drink composition comprising about 74.20-82.47% by weight of water, about 15-20% by weight of flavors, about 2.0-3.0% by weight of minerals, about 0.5-2.5% by weight of maca extract, about 0.02-0.2% by weight of preservatives, and about 0.01-0.1% by weight of vitamins.

8. A nutritional drink composition comprising about 74.100-80.959% by weight of water, about 17-22% by weight of flavors, about 2.0-3.0% by weight of minerals, about 0.02-0.2% by weight of preservatives, and about 0.01-0.1% by weight of vitamins, about 0.01-0.5% by weight of thickeners, and about 0.001-0.1% by weight of vitex extract.
